(19) United States
(12) Patent Application Publication
(10) Pub. No.: US 2012/0112712 A1
(43) Pub. Date: May 10, 2012

(54) POWER FACTORY CORRECTION CIRCUIT AND POWER SUPPLY HAVING THE SAME

(75) Inventors: Taisung Kim, Seoul (KR); Jooho Lee, Daejeon (KR)

(73) Assignee: SAMSUNG ELECTRO-MECHANICS CO., LTD., Gyunggi-Do (KR)

(21) Appl. No.: 13/052,790

(22) Filed: Mar. 21, 2011

(30) Foreign Application Priority Data
Nov. 4, 2010 (KR) 10-2010-0109210

(51) Int. Cl. G05F 1/70

(52) U.S. Cl. 323/207

(57) ABSTRACT

A power supply includes an EMI filter removing noises from an input signal, a rectifying circuit rectifying and outputting the input signal, and a power factor correction circuit varying a magnitude in output voltage according to a duty ratio of a driving signal while generating an output voltage by an energy storage unit storing and discharging energy, controlling the duty ratio of the driving signal according to the change in the output voltage, and controlling the magnitude in output voltage before the output voltage is determined to be in an overvoltage state by using a second threshold voltage to be set lower than the first threshold voltage while determining whether the output voltage is in an overvoltage state by using the first threshold voltage. The power supply controls the magnitude in output voltage before it is determined that the output voltage is in an overvoltage state by being overshot.

### CROSS REFERENCE(S) TO RELATED APPLICATIONS

This application claims the benefit under 35 U.S.C. Section 119 of Korean Patent Application Serial No. 10-2010-0109210, entitled “Power Factor Correction Circuit And Power Supply Having The Same” filed on Nov. 4, 2010, which is hereby incorporated by reference in its entirety into this application.

### BACKGROUND OF THE INVENTION

1. Technical Field

The present invention relates to a power factor correction circuit and a power supply having the same, and more particularly, to a power factor correction circuit capable of previously preventing noise from occurring due to suspending according to an overvoltage state of output voltage and a power supply having the same.

2. Description of the Related Art

Recently, various display devices such as a plasma display panel, a liquid crystal display (LCD), and a light emitting diode (LED) have been developed and distributed. Among others, a light emitting diode display device has been prevalently used due to advantages such as the use of a DC power supply stably and efficiently operated, very small heat generation, low power consumption, etc. The light emitting diode is a device that emits light due to the voltage applied to both terminals thereof. A constant voltage should be stably applied to both terminals of the light emitting diode so that the light emitted from the light emitting diode maintains constant luminance. Therefore, the light emitting display device includes a switching mode power supply (SMPS) supplying the constant voltage.

The switching mode power supply is a device that controls a switching time of a switching device for controlling the increase and reduction in voltage due to a duty ratio of a pulse width modulation (PWM) pulse to generate an output voltage of a desired level and has been prevalently used due to advantages of slimness and lightness. The switching mode power supply continuously monitors the change in output voltage to vary the duty ratio of the PWM pulse according to the change in output voltage, thereby maintaining a predetermined level of output voltage.

Meanwhile, the switching mode power supply is internally set to be an overvoltage level. If the output voltage is the overvoltage level or more due to over-shooting, the switching mode power supply blocks the PWM pulse, thereby stopping the operation of the switching device. In this case, the sudden fluctuation in which the input current becomes suddenly 0 according to the blocking of the PWM pulse occurs. The sudden fluctuation of the input current causes mechanical noises in the EMI filter included in the switching mode power supply.

### SUMMARY OF THE INVENTION

An object of the present invention is to provide a unit capable of preventing mechanical noises of an EMI filter caused due to suspending according to an overvoltage state of an output voltage.

According to an exemplary embodiment of the present invention, there is provided a power factor correction circuit, including: a converter including an energy storage unit storing energy by an input current when a switch is in a first state and changing a level of an output voltage by using the stored energy when the switch is in a second state, the first and second states being controlled according to a duty ratio of a driving signal; a controller controlling the duty ratio of the driving signal according to the change in output voltage and being fedback with the output voltage to determine whether the output voltage is overvoltage by using a first threshold voltage; and a voltage control circuit controlling the controller to reduce a first state period of the switch in order to reduce a level of the output voltage by using a second threshold voltage set to be lower than the first threshold voltage before the output voltage is determined to be overvoltage.

According to another exemplary embodiment of the present invention, there is provided a power factor correction circuit, including: a converter generating an output voltage having a voltage level varied according to a duty ratio of a driving signal; a controller being fedback with a first dividing voltage of the output voltage through a first terminal to control the duty ratio of the driving signal according to the magnitude in the comparison signal while generating a comparison signal corresponding to the voltage difference between the first dividing voltage and the reference voltage and outputting it through a second terminal and being fedback with a second dividing voltage of the output voltage through a third terminal to determine whether the output voltage is overvoltage by using a first threshold voltage, and outputting a reference voltage through a fourth terminal; and a voltage control circuit setting a second threshold voltage lower than the first threshold voltage and if the second dividing voltage is the second threshold voltage or more, reducing the magnitude in the comparison signal through the second terminal.

According to another exemplary embodiment of the present invention, there is provided a power supply, including: an EMI filter removing noises from an input signal; a rectifying circuit rectifying and outputting the input signal; and a power factor correction circuit varying a magnitude in output voltage according to a duty ratio of a driving signal while generating an output voltage by an energy storage unit storing and discharging energy, controlling the duty ratio of the driving signal according to the change in output voltage, and controlling the magnitude in output voltage before the output voltage is determined to be in an overvoltage state by using a second threshold voltage to be set lower than the first threshold voltage while determining whether the output voltage is in an overvoltage state by using the first threshold voltage.

### BRIEF DESCRIPTION OF THE DRAWINGS

FIG. 1 is a diagram showing a power supply according to an exemplary embodiment of the present invention;

FIG. 2 is a circuit diagram showing a voltage control circuit of FIG. 1;

FIG. 3 is a waveform diagram simulating a change in input current when a voltage control circuit is not present in a power supply; and

FIG. 4 is a waveform diagram simulating a change in input current when a voltage control circuit is present in a power supply.

### DESCRIPTION OF THE PREFERRED EMBODIMENTS

Hereinafter, exemplary embodiments of the present invention will be described with reference to the accompanying drawings.

In describing the present invention, when a detailed description of well-known technology relating to the present invention may unnecessarily make unclear the spirit of the present invention, a detailed description thereof will be omitted. Further, the following terminologies are defined in consideration of the functions in the present invention and may be construed in different ways by the intention of users and operators. Therefore, the definitions thereof should be construed based on the contents throughout the specification.

The spirit of the present invention is determined by the claims and the following exemplary embodiments may be provided to efficiently describe the spirit of the present invention to those skilled in the art.

Hereinafter, a power supply according to exemplary embodiments of the present invention will be described with reference to the accompanying drawings.

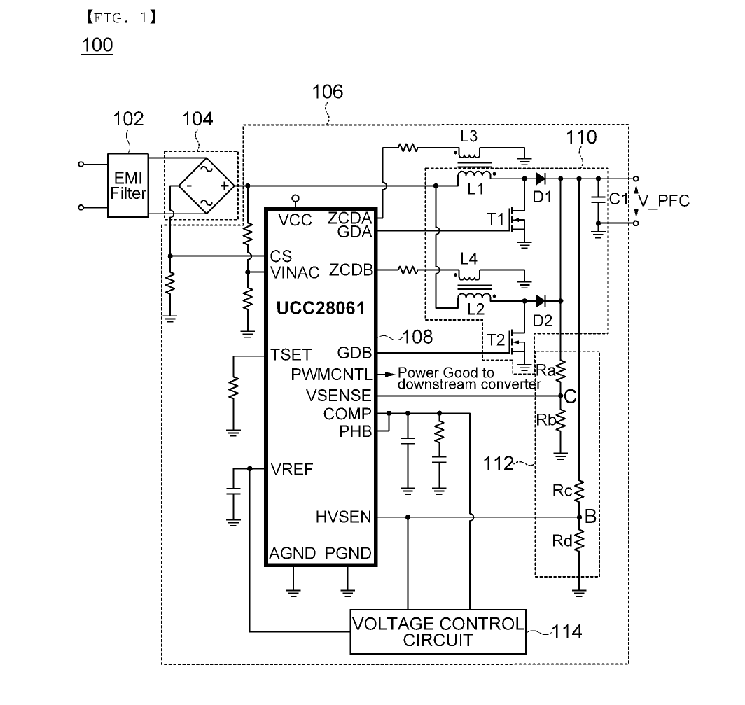

FIG. 1 is a diagram showing a power supply according to an exemplary embodiment of the present invention.

As shown in FIG. 1, a power supply 100 according to the exemplary embodiment of the present invention includes an EMI filter 102, a rectifying circuit 104, and a power factor correction circuit 106.

First, the EMI filter 102 removes noises from an AC input signal input to the power supply 100. The rectifying circuit 104 rectifies the AC input signal, converts it into a DC signal and outputs it. FIG. 1 shows a case in which a bridge full-wave rectifying circuit is applied to the rectifying circuit 104, but other rectifying circuits may be used.

The power factor correction circuit 106 is configured to include a controller chip 108, a converter 110, a voltage dividing circuit 112, and a voltage control circuit 114. In this configuration, a UCC28061 chip manufactured from Texas Instruments is shown as a controller chip 108, which is only an example. The technical idea of the present invention is not limited only to the UCC28061 chip.

The operation of the power factor correction circuit 106 will be described in detail.

The controller chip 108 outputs a gate driving signal through a GDA terminal and a GDB terminal to turn-on or turn-off transistors T1 and T2 of the converter 110. The gate driving signal is the PWM pulse signal having a predetermined duty ratio, wherein the duty ratio indicates a ratio of a high level period for one period of the gate driving signal. The converter 110 varies the electromotive force of the inductors L1 and L2 according to the duty ratio of the gate driving signal to generate a PFC voltage V_PFC having a higher level than the input voltage.

The operation of the converter 110 will be described by dividing the high level period and the low level period of the gate driving signal.

First, if the gate driving signal is activated at the high level, the transistors T1 and T2 are each turned-on and the input current flows through the inductors L1 and L2 and the transistors T1 and T2, respectively. In this case, current converted into magnetic energy is stored in the inductors L1 and L2. The energy stored in the inductors L1 and L2 varies according to the activation period of the gate driving signal.

Next, if the gate driving signal is activated at a low level, the transistors T1 and T2 are each turned-off and the electromotive force is the energy stored in the inductors L1 and L2 and current flows through diodes D1 and D2. In this case, the PFC voltage V_PFC is generated at both terminals of the capacitor C1. The magnitude in the PFC voltage V_PFC varies according to the magnitude in energy stored in the inductors L1 and L2.

That is, if the duty ratio of the gate driving signal is increased, the energy stored in the inductors L1 and L2 is increased, thereby increasing the PFC voltage V_PFC. On the other hand, if the duty ratio of the gate driving signal is reduced, the energy stored in the inductors L1 and L2 is reduced, thereby reducing the PFC voltage V_PFC.

The controller chip 108 controls the duty ratio of the gate driving signal according to the PFC voltage V_PFC that is an output voltage. That is, if the controller chip 108 increases the PFC voltage V_PFC, the duty ratio of the gate driving signal is lowered and if the PFC voltage V_PFC is reduced, the duty ratio of the gate driving signal is increased, thereby maintaining the PFC voltage V_PFC at a predetermined level. Reviewing in detail, the controller chip 108 controls the duty ratio of the gate driving signal according to the voltage difference between a dividing voltage (voltage at node C) dividing the PFC voltage V_PFC by resistors Ra and Rb and a reference voltage VREF. Although not shown, the controller chip 108 includes an error amplifier provided therein and generates a COMP signal having a magnitude corresponding to the voltage difference between the divided voltage (voltage at node C) and the reference voltage VREF through the error amplifier and controls the duty ratio of the gate driving signal corresponding to the magnitude of the COMP signal. In this case, the reference voltage VREF is a voltage between 5.82V to 6.18V, generally, a constant value set to be 6V. As a result, the controller chip 108 controls the duty ratio of the gate driving signal according to the PFC voltage V_PFC.

As described above, when other chips other than the UCC28061 chip are used as the controller chip 108, it is to be apparent that a terminal to which the PFC voltage V_PFC is fedback may vary depending on a specification of the corresponding chip rather than a VSENSE terminal, and the magnitude in the reference voltage VREF may also vary depending on a specification of the corresponding chip.

Meanwhile, a threshold voltage is set in the controller chip 108 in order to monitor whether the PFC voltage V_PFC is overvoltage. Two threshold voltages are set to prepare for case where the controller chip 108 fails to sense the overvoltage. The controller chip 108 monitors the PFC voltage V_PFC through the VSENSE terminal and the HVSEN terminal, respectively, having the threshold voltage set different from each other, thereby determining whether the PFC voltage V_PFC is the overvoltage. In this case, using two terminals, i.e., the VSENSE terminal and the HVSEN terminal in order to sense the overvoltage is characteristics of the UCC28061 chip and a chip in which only a single terminal for sensing the overvoltage is set may be used as the controller chip 108.

$$\begin{matrix}V\_OVP1 = 6.45 \times \frac{Ra + Rb}{Rb} & [ Equation 1 ] \\ V\_OVP2 = 4.87 \times \frac{Rc + Rd}{Rd} & [ Equation 2 ]\end{matrix}$$

The controller chip 108 is fedback in the divided voltage form of the PFC voltage V_PFC rather than being fedback with the PFC voltage V_PFC as it is and compares them with a first threshold voltage V_OVP1 and a second threshold voltage V_OVP2, thereby determining whether the PFC voltage V_PFC is the overvoltage. The controller chip 108 determines the PFC voltage V_PFC as the overvoltage state when the divided voltage (voltage at node C) of the PFC voltage V_PFC applied to the VSENSE terminal is the first threshold voltage V_OVP1 or more obtained by Equation 1 or when the divided voltage (voltage at node B) of the PFC voltage V_PFC applied to the HVSEN terminal is a second threshold voltage V_OP2 or more obtained by Equation 2. However, if it is determined that the PFC voltage V_PFC is in the overvoltage state, the controller chip 108 blocks the gate driving signal to inactivate the converter 110. Meanwhile, if the divided voltages of the PFC voltage V_PFC applied to each of the HVSEN terminal and the VSENSE terminal return in the normal range, the controller chip 108 again generates the gate driving signal to activate the converter 110. In this case, 4.87V is a voltage originally set in the chip design in order to sense the overvoltage through the HVSEN terminal and 6.45V is a voltage originally set in the chip design for sensing the overvoltage through the VSENSE terminal. However, as indicated in Equations 1 and 2, the first threshold voltage V_OVP1 varies by resistance values Ra and Rb connected to the HVSEN terminal and the second threshold voltage V_OVP2 varies by resistance values Rc and Rd connected to the VSENSE terminal.

Meanwhile, since a constant used in Equations 1 and 2, i.e., 4.87V and 6.45V are values set in the UCC28061 chip design, the set values is substituted into Equations 1 and 2 at the time of designing the corresponding chip when other chips are used as the controller chip 108 of the present invention.

Meanwhile, the power factor correction circuit 106 may implement a zero voltage switching operation in order to increase the switching efficiency, which can be implemented by repeatedly performing a process of increasing the current amount stored in the inductors L1 and L2 for a predetermined time and then increasing the PFC voltage V_PFC stored in the capacitor C1 by turning-off the transistors T1 and T2 until the stored current becomes 0 and again storing current to the inductors L1 and L2. In this case, the controller chip 108 may determine the current state of the inductors L1 and L2 by supplying current introduced from inductors L3 and L4 generating current according to the change in magnetic field of the inductors L1 and L2 to a ZCDA terminal and a ZCDB terminal.

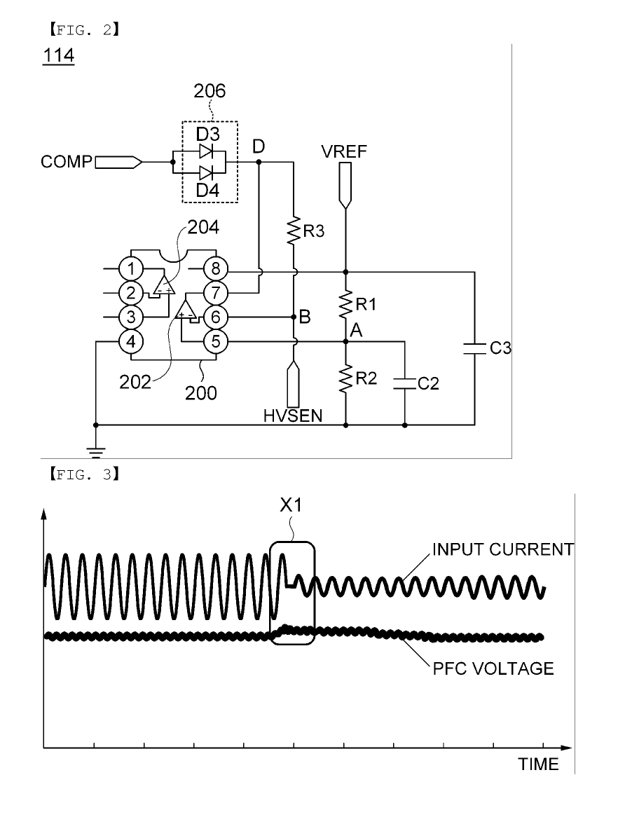

FIG. 2 is a circuit diagram showing a voltage control circuit of FIG. 1.

As shown in FIG. 2, the voltage control circuit 114 of the present invention includes a driving chip 200 including two comparators 202 and 204 and a gap maintaining part 206. In FIG. 2, only one of two comparators 202 and 204 included in the driving chip 200 is used.

Referring to FIG. 2, a non-inverting input terminal of the comparator 202 is connected to pin 5 of the driving chip 200, an inverting input terminal thereof is connected to pin 6 of the driving chip 200, and an output terminal thereof is connected to pin 7 thereof. In addition, the comparator 202 uses the reference voltage VREF applied through pin 8 as +power and uses the ground voltage applied through pin 4 as −power.

Meanwhile, the resistors R1 and R2 are connected to the VREF terminal outputting the reference voltage VREF and the ground terminal in series and the node A between the resistor R1 and the resistor R2 is connected to the non-inverting input terminal of the comparator 202 through pin 5 of the driving chip 200. A resistor R3 is connected between pin 6 and 7 of the driving chip 200 and the gap maintaining part 206 is connected between pin 7 of the driving chip 200 and the COMP terminal outputting the COMP signal. The gap maintaining part 206 is configured of diodes D3 and D4 whose anodes are connected to the COMP terminal and cathodes are connected to pin 7 of the driving chip 200. The diodes D3 and D4 are connected in parallel.

The voltage control circuit 114 has a third threshold voltage having a value larger than the desired PFC voltage V_PFC and smaller than the first threshold voltage V_OVP1 and the second threshold voltage V_OVP2. The voltage control circuit 114 reduces the voltage of the COMP signal of the controller chip 108 when the PFC voltage V_PFC becomes the third threshold voltage or more by being overshot in order to reduce the duty ratio of the gate driving signal, thereby preventing the rising of the PFC voltage V_PFC and maintaining the PFC voltage V_PFC at the desired voltage level. That is, the voltage control circuit 114 controls the voltage level before the PFC voltage V_PFC reaches the first threshold voltage V_OVP1 or the second threshold voltage V_OVP2, such that it prevents the PFC voltage V_PFC from arriving at the overvoltage state.

Hereinafter, a method of setting the third threshold voltage in the voltage control circuit 114 will be described below.

V_PFC≦V_OVP3≦V_OVP2≦V_OVP1 [Equation 3]

As being represented by Equation 3, the third threshold voltage set in the voltage control circuit 114 is in the range between the desired PFC voltage V_PFC or more and the second threshold voltage V_OVP2 or less. In this case, the controller chip 108 can control the voltage control of the PFC voltage V_PFC before the PFC voltage V_PFC is determined to be the overvoltage state. In this case, the second threshold voltage V_OVP2 has a value equal to or smaller than the first threshold voltage V_OVP1.

$$\begin{matrix}V\_B = V\_OVP3 \times \frac{Rd}{Rc + Rd} = V\_A & [ Equation 4 ] \\ V\_OVP3 = V\_A \times \frac{Rc + Rd}{Rd} & [ Equation 5 ] \\ V\_PFC = V\_B \times \frac{Rc + Rd}{Rd} & [ Equation 6 ]\end{matrix}$$

The operational point in which the voltage control circuit 114 starts to drop the voltage of the COMP signal is a time point in which node B voltage V_B is equal to node A voltage V_A. This is represented by Equation 4 and the third threshold voltage V_OVP3 set by node A is represented by Equation 5.

Meanwhile, the PFC voltage V_PFC is a voltage divided by the resistors Rc and Rd, which may be defined by Equation 6.

As described above, the first threshold voltage V_OVP1, the second threshold voltage V_OVP2, the third threshold voltage V_OVP3, and the PFC voltage V_PFC are defined by Equation 1, Equation 2, Equation 5, and Equation 6, respectively, which are substituted into Equation 3 to derive Equations 7 and 8.

$$\begin{matrix}V\_B \times \frac{Rc + Rd}{Rd} \leq V\_A \times \frac{Rc + Rd}{Rd} \leq 4.87 \times \frac{Rc + Rd}{Rd} & [ Equation 7 ] \\ V\_B \leq V\_A \leq 4.87 & [ Equation 8 ]\end{matrix}$$

Referring to Equation 8, it can be appreciated that the voltage V_A of node A is set to be 4.78V or less while it is set to be the voltage V_B of node B or more.

$$\begin{matrix}V\_A = VREF \times \frac{R 2}{R 1 + R 2} & [ Equation 9 ] \\ \frac{VREF}{4.87} - 1 \leq \frac{R 1}{R 2} \leq \frac{VREF}{V\_B} - 1 & [ Equation 10 ]\end{matrix}$$

Meanwhile, the voltage V_A of node A may be defined by Equation 9 and Equation 10 may be derived by Equations 8 and 9. The resistors R1 and R2 determining the voltage V_A of node A may be set by Equations 8, 9, and 10.

The third threshold voltage V_OVP3 is set by the voltage V_A of node A, which is used as the reference voltage input to the non-inverting input terminal of the comparator 202. Therefore, the comparator 202 compares the dividing voltage of the PFC voltage V_PFC input to the inverting input terminal through pin 6 and the third threshold voltage V_OVP3 input to the non-inverting input terminal, thereby outputting +voltage or −voltage.

The operation of the voltage control circuit 114 will be described below according to the comparison results between the dividing voltage of the PFC voltage V_PFC and the third threshold voltage V_OVP3.

First, when the dividing voltage of the PFC voltage V_PFC is smaller than the third threshold voltage V_OVP3, the comparator 202 outputs +voltage through pin 7 of the driving chip 200. The comparator 202 is operated by being applied with the reference voltage VREF as +power, thereby outputting the voltage of about 6V. In this case, the reverse bias is applied between the gap maintaining parts 206 connected between the COMP terminal and pin 7 of the driving chip 200, such that current does not flow in the gap maintaining part 206. That is, the voltage control circuit 114 is not operated.

Meanwhile, when the dividing voltage of the PFC voltage V_PFC is more than the third threshold voltage V_OVP3, the comparator 202 outputs −voltage through pin 7 of the driving chip 200. The comparator 202 is operated by receiving the ground voltage as −power, such that the ground voltage is output. In this case, the forward bias is applied between the gap maintaining parts 206, such that current flows, thereby lowering the potential of the COMP terminal of the controller chip 108. Therefore, since the voltage level of the COMP signal is lowered, such that the controller chip 108 lowers the duty ratio of the gate driving signal corresponding to the COMP signal, thereby preventing the rising of the PFC voltage V_PFC. That is, the voltage control circuit 114 controls the controller chip 108 to control the level of the PFC voltage V_PFC.

As described above, the voltage control circuit 114 monitors the level change of the PFC voltage V_PFC through the dividing voltage obtained by dropping the PFC voltage V_PFC to a predetermined level. When the dividing voltage rises to the third threshold voltage V_OVP3 or more, the voltage control circuit 114 controls the controller chip 108 to control the PFC voltage V_PFC, thereby preventing the additional rising of the PFC voltage V_PFC. Therefore, before the PFC voltage V_PFC is overshot and then, enters the overvoltage state due to the controller chip 108, the voltage control circuit 114 controls the voltage level of the PFC voltage V_PFC, thereby making it possible to previously prevent the noise of the EMI filter caused due to the operation of the controller chip 108.

Meanwhile, the voltage control circuit 114 includes the gap maintaining part 206 to prevent the potential of the HVSEN terminal from dropping to 0.8V or less. When the HVSEN terminal drops to 0.8V or less, the controller chip 108 stops a normal operation and enters into the test mode. That is, the UCC28061 chip maintains a normal mode only when the HVSEN terminal maintains 0.8V or more, such that it can be operated normally.

The gap maintaining part 206 maintains the voltage between the COMP terminal and pin 7 of the driving chip 202 at a minimum 0.8V, that is, the minimum voltage or more of the predetermined HVSEN terminal in order for the UCC28061 chip to maintain a normal mode, thereby making it possible to prevent the HVSEN terminal from dropping to 0.8V or less.

The voltage control circuit 114 applies the reverse bias to the gap maintaining part 206 when the dividing voltage of the PFC voltage V_PFC is smaller than the third threshold voltage V_OVP3 and when the dividing voltage of the PFC voltage V_PFC is the third threshold voltage V_OVP3 or more, the forward bias is applied to the gap maintaining part 206, such that the gap of 0.8V or more is maintained between the COMP terminal and pin 7 of the driving chip 202. Therefore, the voltage control circuit 114 prevents the controller chip 108 from entering into a test mode by dropping the HVSEN terminal to 0.8V or less by the gap maintaining part 206, independent of the operational state.

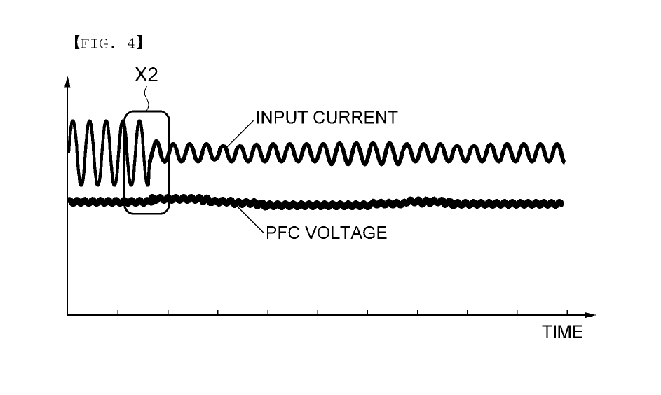

FIG. 3 is a waveform diagram simulating a change in input current when a voltage control circuit is not present in a power supply and FIG. 4 is a waveform diagram simulating a change in input current when a voltage control circuit is present in a power supply.

First, the case in which the voltage control circuit is not present in the power supply will be described below.

As shown in the box portion X1 of FIG. 3, if the PFC voltage is instantly overshot and exceeds the threshold voltage set in the controller chip, it is determined that the controller chip is an overvoltage state, thereby blocking the gate driving signal. Therefore, since the input current becomes 0, it is suddenly fluctuated. In this case, the EMI filter of the power supply may cause the mechanical noise due to the sudden fluctuation of the input current.

Next, the case in which the voltage control circuit is present in the power supply will be described below.

As shown in the box portion X2 of FIG. 4, when the PFC voltage is overshot, the voltage control circuit monitors the PFC voltage before the PFC voltage rises up to the threshold voltage set in the controller chip to control the controller chip, thereby stopping the rising of the PFC voltage. Therefore, since it is possible to prevent the gate driving signal from being blocked due to the controller chip by increasing the PFC voltage to some degree, stopping it, and again dropping it, it can be appreciated that a portion in which the input current becomes 0 and the input current is suddenly fluctuated disappears, as compared to FIG. 3.

As described above, the controller chip 108 of the present invention stops the operation of the converter 110 when the PFC voltage V_PFC is determined as the overvoltage by determining whether the PFC voltage V_PFC is the overvoltage through the HVSEN terminal and the VSENSE terminal, thereby causing the sudden fluctuation of the input current. However, the voltage control circuit 114 senses the PFC voltage V_PFC before the PFC voltage V_PFC is in the overvoltage state to control the controller chip 108, thereby lowering the PFC voltage V_PFC. As a result, the noise of the EMI filter caused by the controller chip 108 can be previously prevented in the state where the PFC voltage V_PFC is in the overvoltage state.

In addition, the voltage control circuit 114 prevents the controller chip 108 from entering into a test mode by preventing the HVSEN terminal from dropping to 0.8V or less by the gap maintaining part 206 provided therein.

Meanwhile, the controller chip 108 according to the exemplary embodiment of the present invention is an example in which the UCC28061 of T1 is applied. Therefore, when other chips are applied to the controller chip 108 of the present invention, instead of the UCC28061, the values defined in the specification of the corresponding chip are instead applied to the above Equations. In addition, in order to achieve the objects of the present invention, the terminals of the corresponding chip performing the same functions as the COMP terminal, the HAVSEN terminal, the VSENSE terminal, etc., of the UCC28061 chip may be configured according to FIGS. 1 and 2.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

Accordingly, the scope of the present invention is not construed as being limited to the described embodiments but is defined by the appended claims as well as equivalents thereto.

1. A power factor correction circuit, comprising:
a converter including an energy storage unit storing energy by an input current when a switch is in a first state and changing a level of an output voltage by using the stored energy when the switch is in a second state, the first and second states being controlled according to a duty ratio of a driving signal;
a controller controlling the duty ratio of the driving signal according to the change in output voltage and being fedback with the output voltage to determine whether the output voltage is overvoltage by using a first threshold voltage; and
a voltage control circuit controlling the controller to reduce a first state period of the switch in order to reduce a level of the output voltage by using a second threshold voltage set to be lower than the first threshold voltage before the output voltage is determined to be overvoltage.

2. The power factor correction circuit according to claim 1, wherein the second threshold voltage is set in the range between the desired level value of the output voltage and the first threshold voltage.

3. The power factor correction circuit according to claim 1, wherein the controller outputs a comparison signal corresponding to the voltage difference between a first dividing voltage of the output voltage and a reference voltage and controls a duty ratio of the driving signal corresponding to the magnitude in the comparison signal.

4. The power factor correction circuit according to claim 3, wherein the voltage control circuit reduces the magnitude in the comparison signal when a second dividing voltage of the output voltage is the second threshold voltage or more.

5. The power factor correction circuit according to claim 3, wherein the controller includes a first terminal receiving the first dividing voltage, a second terminal outputting the comparison signal, a third terminal receiving the second dividing voltage, and a fourth terminal outputting the reference voltage.

6. The power factor correction circuit according to claim 5, wherein the voltage control circuit includes:
a comparator including a non-inverting input terminal connected to a first node between a first resistor and a second resistor connected between the first terminal and a ground terminal in series, an inverting input terminal connected to the third terminal, an output terminal connected to the second terminal, a third resistor being connected between the inverting input terminal and the output terminal; and
a gap maintaining part connected between the output terminal of the comparator and the second terminal of the controller and forming the voltage difference of a predetermined minimum voltage or more of the third terminal in order to maintain a normal mode of the controller.

7. The power factor correction circuit according to claim 6, wherein the gap maintaining part is configured of at least one diode whose an anode is connected to the second terminal and a cathode is connected to the output terminal of the comparator.

8. A power factor correction circuit, comprising:
a converter generating an output voltage having a voltage level varied according to a duty ratio of a driving signal;
a controller being fedback with a first dividing voltage of the output voltage through a first terminal to control the duty ratio of the driving signal according to the magnitude in the comparison signal while generating a comparison signal corresponding to the voltage difference between the first dividing voltage and the reference voltage and outputting it through a second terminal and being fedback with a second dividing voltage of the output voltage through a third terminal to determine whether the output voltage is overvoltage by using a first threshold voltage, and outputting a reference voltage through a fourth terminal; and
a voltage control circuit setting a second threshold voltage lower than the first threshold voltage and if the second dividing voltage is the second threshold voltage or more, reducing the magnitude in the comparison signal through the second terminal.

9. The power factor correction circuit according to claim 8, wherein the second threshold voltage is set in the range between the desired level of the output voltage and the first threshold voltage.

10. The power factor correction circuit according to claim 8, wherein the voltage control circuit includes:
a comparator of which the non-inverting input terminal is connected to a first node between a first resistor and a second resistor connected between a fourth terminal of the controller and a ground terminal, the inverting input terminal is connected to the third terminal, and the output terminal is connected to the second terminal, a third resistor being connected between the inverting input terminal and the output terminal; and
a gap maintaining part connected between the output terminal of the comparator and the second terminal of the controller and forming the voltage difference of a predetermined minimum voltage or more of the third terminal in order to maintain a normal mode of the controller, independent of the output of the comparator.

11. The power factor correction circuit according to claim 10, wherein the gap maintaining part maintains the voltage difference of the predetermined minimum voltage or more of the third terminal even in the output of the comparator to maintain the potential of the third terminal at the predetermined minimum voltage or more.

12. The power factor correction circuit according to claim 11, wherein the gap maintaining part includes at least one diode of which the anode is connected to the second terminal and the cathode is connected to the output terminal of the comparator.

13. A power supply, comprising:
an EMI filter removing noises from an input signal;
a rectifying circuit rectifying and outputting the input signal; and
a power factor correction circuit varying a magnitude in output voltage according to a duty ratio of a driving signal while generating an output voltage by an energy storage unit storing and discharging energy, controlling the duty ratio of the driving signal according to the change in output voltage, and controlling the magnitude in output voltage before the output voltage is determined to be in an overvoltage state by using a second threshold voltage to be set lower than the first threshold voltage while determining whether the output voltage is in an overvoltage state by using the first threshold voltage.

14. The power supply according to claim 13, wherein the power factor correction circuit includes:
a controller controlling the duty ratio of the driving signal according to the change in output voltage and determining the output voltage as the overvoltage when the first dividing voltage of the output voltage is the first threshold voltage or more; and
a voltage control circuit controlling the duty ratio of the driving signal by controlling the controller when the second dividing voltage of the output voltage is the second threshold voltage or more set to be lower than the first threshold voltage.

15. The power supply according to claim 13, wherein the second threshold voltage is set in the range between the desired level of the output voltage and the first threshold voltage.

16. The power supply according to claim 14, wherein the controller outputs the comparison signal corresponding to the voltage difference between the first dividing voltage of the output voltage and the reference voltage and controlling the duty ratio of the driving signal corresponding to the magnitude in comparison signal.

17. The power supply according to claim 16, wherein the voltage control circuit reduces the magnitude in comparison signal when the second dividing voltage of the output voltage is the second threshold voltage or more.

18. The power supply according to claim 14, wherein the controller includes a first terminal receiving the first dividing voltage, a second terminal outputting the comparison signal, a third terminal receiving the second dividing voltage, and a fourth terminal outputting the reference voltage.

19. The power supply according to claim 18, wherein the voltage control circuit includes:
a comparator of which the non-inverting input terminal is connected to a first node between a first resistor and a second resistor connected between the first terminal and a ground terminal in series, the inverting input terminal is connected to the third terminal, and the output terminal is connected to the second terminal, a third resistor being connected between the inverting input terminal and the output terminal; and
a gap maintaining part connected between the output terminal of the comparator and the second terminal of the controller and forming the voltage difference of a predetermined minimum voltage or more of the third terminal in order to maintain a normal mode of the controller.

20. The power supply according to claim 19, wherein the gap maintaining part is configured of at least one diode of which the anode is connected to the second terminal and the cathode is connected to the output terminal of the comparator.
